(19) United States
(12) Patent Application Publication
(10) Pub. No.: US 2004/0230753 A1
(43) Pub. Date: Nov. 18, 2004

(54) Methods and apparatus for providing service differentiation in a shared storage environment

(75) Inventors: Khalil Amiri, Toronto (CA); Seraphin Bernard Calo, Cortlandt Manor, NY (US); Bong-Jun Ko, New York, NY (US); Kang-Won Lee, Nanuet, NY (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 10/439,761

(22) Filed: May 16, 2003

(51) Int. Cl. G06F 12/00

(52) U.S. Cl. 711/147; 711/170

(57) ABSTRACT

Apparatus and techniques for automatically allocating storage space among classes of applications and/or users in a shared storage environment are proposed. In one illustrative embodiment, such apparatus includes: (i) a plurality of per-class controllers, each per-class controller being operative to determine a cache space allocation for its corresponding class based on a current measured hit rate and a current cache space allocation for its corresponding class; and (ii) a contention resolver coupled to the plurality of per-class controllers and operative to resolve cache space allocation in response to conflicting requests from at least two of the per-class controllers. The apparatus may also include a fairness controller coupled to the plurality of per-class controllers and the contention resolver for computing a fair cache allocation share of each class based on a current performance estimate and a target hit rate of each class, wherein the fairness controller adjusts the target hit rate of each class that the per-class controller is to track.

### FIELD OF THE INVENTION

The present invention relates to shared storage environments and, more particularly, to techniques for providing service differentiation in such shared storage environments.

### BACKGROUND OF THE INVENTION

As storage resources have become increasingly consolidated and shared, it has become apparent that a need exists to provide service differentiation among competing applications sharing the same infrastructure.

In Y. Lu et al., “LDU Parametrized Discrete Time Multivariable MRAC and Application to a Web Cache System,” IEEE Conference on Decision and Control, Las Vegas, Nev., December 2002, the disclosure of which is incorporated by reference herein, a QoS algorithm for Web proxies proposes to provide multiple classes of services to Internet clients. Their solution, however, does not provide absolute hit rate guarantees, but only supports relative hit rate ratios between classes. This restriction does not match the needs of many applications which require specific and explicit hit rate/response time goals. Secondly, their solution does not scale to large-scale storage systems since it essentially is a MIMO (multi-input-multi-output) feedback control system, the computation of which becomes prohibitively complex as the number of application classes increases even to a small number.

In U.S. Pat. No. 5,394,531 issued to K. Smith on Feb. 28, 1995, entitled “Dynamic Storage Allocation System for a Prioritized Cache,” the disclosure of which is incorporated by reference herein, a storage cache management technique is provided, wherein cache space is dynamically partitioned to provide an equivalent hit ratio for each cache partition. However, such a storage cache management technique does not encompass the notion of quality of service (QoS) and the technique relates to direct attached storage systems.

Thus, a need still exists for techniques which are able to provide effective service differentiation among competing applications and/or users sharing the same storage infrastructure.

### SUMMARY OF THE INVENTION

The present invention provides dynamic and scaleable techniques for storage space allocation so as to provide effective service differentiation among competing applications and/or users sharing the same storage infrastructure.

In a first aspect of the invention, an automated technique for allocating storage space among classes of applications and/or users in a shared storage environment, includes the following steps/operations. First, a storage access request is obtained from at least one application and/or user. Then, a storage space allocation is determined for the storage access request based on an access pattern associated with the at least one application and/or user and a prespecified target response time goal associated with a class of the at least one application and/or user.

The storage space may include cache storage space. The step/operation of determining a storage space allocation for the storage access request may also be based on a prespecified priority level associated with the class of the at least one application and/or user. The target response goal may specify that, for the given class of the at least one application and/or user, an average hit rate measured over a given time period is not less than a target hit rate. Further, when a conflict exists between the storage access request and another storage access request from at least another application and/or user, the allocation technique may include determining a storage space allocation for both storage access requests by resolving the conflict based on a contention resolution policy. Still further, the allocation technique may include distributing excess storage space based on a fairness policy.

In a second aspect of the invention, the automated technique of allocating storage space among classes of applications in a shared storage environment is based on a service level agreement between an owner of the application and a service provider.

In a third aspect of the invention, apparatus for allocating cache space among classes of applications and/or users in a shared storage environment includes: (i) a plurality of per-class controllers, each per-class controller being operative to determine a cache space allocation for its corresponding class based on a current measured hit rate and a current cache space allocation for its corresponding class; and (ii) a contention resolver coupled to the plurality of per-class controllers and operative to resolve cache space allocation in response to conflicting requests from at least two of the per-class controllers. The apparatus may also include a fairness controller coupled to the plurality of per-class controllers and the contention resolver for computing a fair cache allocation share of each class based on a current performance estimate and a target hit rate of each class, wherein the fairness controller adjusts the target hit rate of each class that the per-class controller is to track.

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating a distributed computing environment in which a proxy cache storage system may be implemented, according to an embodiment of the present invention;

FIG. 2 is a block diagram illustrating a proxy cache storage system, according to an embodiment of the present invention;

FIG. 3 is a representation illustrating exemplary pseudo code of a retrospective control methodology for a single class, according to an embodiment of the present invention; and

FIG. 4 is a block diagram illustrating an exemplary computing system environment for implementing a proxy cache storage system, according to an embodiment of the present invention.

### DETAILED DESCRIPTION OF PREFERRED EMBODIMENTS

The following description will illustrate the invention using an exemplary proxy cache storage environment. It should be understood, however, that the invention is not limited to use with any particular storage environment. The invention is instead more generally applicable for use with any shared storage environment in which it is desirable to provide service differentiation among multiple applications and/or users. As used herein, the term “application” generally refers to a software program(s) that may be invoked to perform one or more functions. The invention is not limited to any particular application.

Furthermore, it is realized that the teachings of the present invention may find application in accordance with storage system outsourcing, where the same storage system at a service provider is used to store the data of several classes of remote customers. In such environments, service differentiation among different applications and user classes is particularly important because contentions can arise between the applications and/or users over the commonly shared storage resources and not all applications and/or users are equally important.

As is known, caching is a fundamental and pervasive technique employed to improve the performance of storage systems. Consequently, providing differentiated services from a storage cache is a crucial component of the entire end-to-end quality of service (QoS) solution.

In accordance with illustrative descriptions to follow, the present invention defines the problem of service differentiation in a storage cache as that of achieving specified hit rate goals for a number of competing classes sharing the cache. As is known, “hit rate” is the chief measurement of a cache and is defined as the percentage of all accesses that are satisfied by the data in the cache. More specifically, the problem is that of dynamically allocating cache resources across classes to achieve the specified goals. Since applications change their access patterns and working sets, allocation is adaptive.

While goals may be illustratively specified in terms of cache hit rate, it is to be understood that the invention is not so limited. That is, the invention may be applied in terms of goals other than hit rate, such as the average I/O delay. Furthermore, goals associated with the storage services focus more generally on access latency (e.g., response times) associated with read and/or write operations.

Advantageously, the present invention provides a QoS architecture for a storage proxy cache which can provide long-term hit rate assurances to competing classes. As will be described in detail below, an illustrative proxy cache storage architecture may include three components: (a) per-class feedback controllers that track the performance of each class; (b) a fairness controller that allocates excess resources fairly in the case when all goals are met; and (c) a contention resolver that decides cache allocation in the case when at least one class does not meet its target hit rate.

As will be evident, while other types of per-class feedback controllers may be employed, a retrospective per-class controller, described below, provides a preferred mechanism for tracking class performance while not incurring excessive fluctuation in space allocation. Once the minimum target service levels have been achieved, the fairness controller allocates excess cache resources fairly across competing classes. In addition to achieving the long term service levels, the inventive architecture can handle temporary overloads based on a high level policy and ensure that high priority classes do not experience short term service violations.

For ease of reference, the remainder of the detailed description is divided into the following two sections: (I) Problem and Solution Statement; and (II) Illustrative Architecture.

I. Problem and Solution Statement

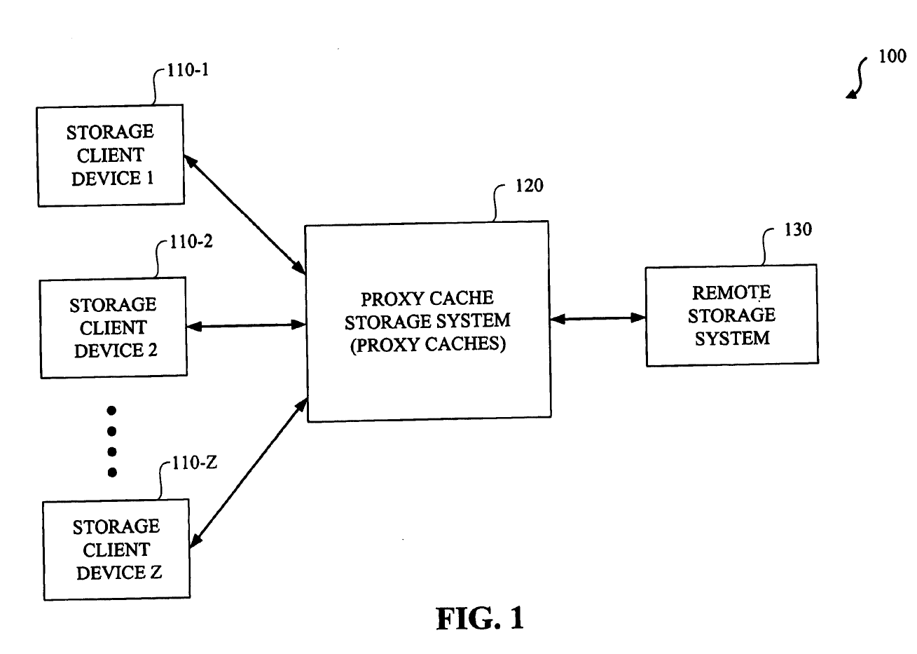

Referring initially to FIG. 1, a block diagram illustrates a distributed computing environment in which a proxy cache storage system may be implemented, according to an embodiment of the present invention. As shown in FIG. 1, distributed computing network 100 includes a plurality of storage client devices 110-1 through 110-Z, a proxy cache storage system 120, and a remote storage system 130. In general, storage client devices 110-1 through 110-Z utilize proxy cache storage system 120 to access remote storage system 130.

The terms of use and performance associated with the storage systems shown in FIG. 1 may be the subject of one or more service level agreements (SLAs) agreed upon between the storage clients and a service provider. The service provider hosts the storage services in accordance with the storage infrastructure.

While storage system 130 is depicted as being remote from the proxy cache storage system 120, this is not required. That is, proxy cache storage system 120 could be co-located with storage system 130. Also, one or more client devices could be co-located with either 120 or both storage systems 120 and 130. Proxy cache storage system 120 includes a plurality of storage caches (also referred to herein as “proxies”) and is where the QoS methodology of the invention may be implemented. The remote storage system 130 may be a back-end storage system such as a collection of disk or disk arrays, or a tape-based system. Also, it is to be understood that the components shown in FIG. 1 are coupled via a suitable communications network, e.g., the Internet, a storage area network, a local area network, etc. However, the invention is not intended to be limited to any particular communications network.

Still further, the proxies that make up the proxy cache storage system 120 may, themselves, be located at different locations or sites. In such case, they too would be coupled via a suitable communications network. The same may be true for the disk or tape devices that make up back-end storage system 130, i.e., they may be distributed in the network.

Disk read and write requests from storage client devices 110-1 through 110-Z are sent to the remote storage location 130 through the storage proxy caches of system 120. Advantageously, storage proxy caches hide disk access latency by caching frequently accessed disk objects. Caching of data associated with both read and write operations may occur. In the case of write caching, standard techniques for maintaining consistency across distributed caches are assumed, see, e.g., J. H. Howard et al., “Scale and Performance in a Distributed File System,” ACM Transactions on Computer Sciences, vol. 6, no. 1, 1998; and M. N. Nelson et al., “Caching in the Sprite Network File System,” ACM Transactions on Computer Systems, vol. 6, no. 1, 1988, the disclosures of which are incorporated by reference herein.

It is also assumed that requests submitted to the caches are tagged according to the application class they belong to, for example, based on application types (e.g., c₁ for the file server workload, C₂ for database accesses) or user identification (e.g., c₁ for privileged users, C₂ for regular users). C={C₁,C₂, . . . , Cₙ} denotes the set of application classes.

A service level goal of the QoS methodology of the invention is to satisfy a given average access latency for disk I/O (input/output) operations measured over a long-term interval. More specifically, the service level agreement (SLA) with the clients can be described as follows: the average access latency of class cᵢ must be less than or equal to lᵢ^{*} (milliseconds) measured over Tₘ (minutes). Here, lᵢ^{*} represents the target access latency of class cᵢ, and Tₘ represents a measurement time window. Tₘ may typically be on the order of a few tens of minutes or a few hours, although other time windows may be specified.

In the shared storage model described above, the storage access latency lᵢ of class cᵢ may be determined by three parameters: (1) average access latency to the local proxy (l_{local}); (2) hit rate in the proxy cache (hᵢ); and (3) average access latency to the remote storage location (lᵣₑₘₒₜₑ) More precisely:

lᵢ=hᵢ*l_{local}+(1−hᵢ)* lᵣₑₘₒₜₑ. (1)

Assuming that l_{local} is a small constant and lᵣₑₘₒₜₑ is the same across different classes, i.e., there is no network level service differentiation per class, the access latency lᵢ is effectively determined by the hit ratio hᵢ.

In other words, it is possible to control the average access latency lᵢ of class cᵢ by controlling the observed hit rate hᵢ at the proxy, and therefore, the QoS methodology of the invention attempts to satisfy the access latency requirement of each class by controlling the hit ratio of the class. More specifically, the QoS methodology of the invention controls the cache space allocated to each class to meet its hit rate target, which will result in an overall response time lᵢ≦lᵢ^{*}. Such a hit rate is referred to as the reference or target hit rate of class cᵢ and is denoted by tᵢ. Using this notation, the service goal can be restated as follows:

For every class cᵢ, the average hit rate hᵢ measured over Tₘ is greater than or equal to its target tᵢ.

Note that the service goal defines a performance metric that guarantees a minimum level of service to the clients over a prespecified period. Such a guarantee may be achieved in association with a provisioning module (not shown), which ensures that the aggregate client requests can be satisfied by the current cache space and performs admission control based on long term workload analysis, see, e.g., G. Alvarez, “Minerva: An Automated Resource Provisioning Tool for Large-scale Storage Systems,” ACM Transactions on Computer Systems, vol. 19, no. 4, 2001, the disclosure of which is incorporated by reference herein.

It is to be understood that the QoS methodology of the invention may handle a potentially large number of competing classes. Since dynamic partitioning of a shared cache among multiple application classes may involve responding to complex and dynamic interactions between classes, the QoS methodology of the invention provides a scaleable and efficient solution to handle multiple service classes.

Further, it is evident that designing an effective cache space controller to closely track a given hit rate places another challenge. We have found that allocating more cache space does not always translate into increased cache hit rate, in particular, when the working set size increases at a greater rate than the cache space increase. This time-varying property, coupled with workload heterogeneity across different applications, highlights the need for a controller that is robust to workload heterogeneity and changes, and to the choice of controller configuration parameters. As will be evident, the invention provides such characteristics.

Still further, although an external provisioning module may be used to meet long term service goals, short term contention can occur due to dynamic variations in the workload. Since such variations are prevalent in practice, the invention provides an effective mechanism to handle temporary overloads (e.g., contention resolver). On the other hand, it is often desirable to allocate excess cache space resources, when all target service levels are met, fairly across applications. The invention also provides a mechanism to ensure such fairness (e.g., fairness controller).

In the next section, a detailed description is provided of an illustrative architecture for proxy cache storage system 120 of FIG. 1, including a set of mechanisms that ensure the target service level goals and address the design challenges described in this section.

II. Illustrative Architecture

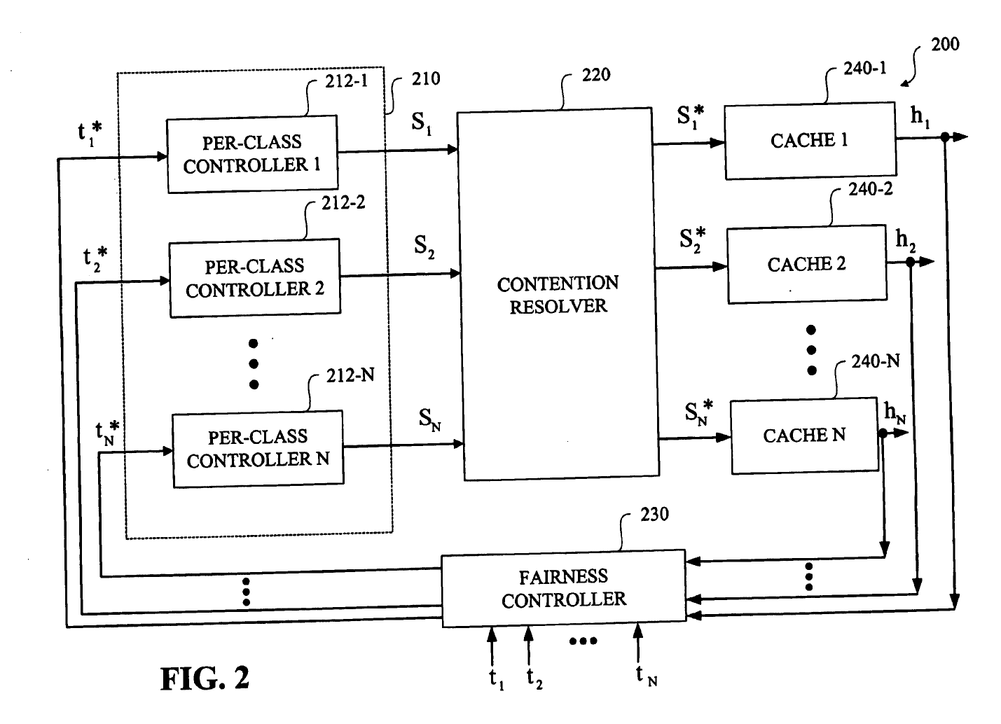

Referring now to FIG. 2, a block diagram illustrates a proxy cache storage system, according to an embodiment of the present invention. It is to be appreciated that system 200, shown in FIG. 2, may be implemented in proxy cache storage system 120 of FIG. 1. The QoS architecture provided by system 200 includes a block 210 of per-class controllers 211-1 through 212-N, a contention resolver 220, a fairness controller 230, and caches (proxies) 240-1 through 240-N. N is an integer number representing the number of classes and, thus, the number of caches. It is to be appreciated that while the total cache space available for allocation may generally be referred to as a “cache,” the individual cache space allocated for an application and/or user may also be referred to as a “cache.” It will be clear from the context whether “cache” is referring to the total cache space or cache space allocated to a particular class from the total cache space.

Each of the components will now be generally described, followed by a detailed description of their respective operations.

Each application class is associated with a per-class controller 212. The per-class controller is a feedback controller that determines the cache space allocation for the class based on the current measured hit rate and the current space allocation for that class. It is to be noted that each per-class controller operates independently of the others, basing its operation on the feedback information from its own class. In this way, controller complexity is kept to a minimum.

As previously mentioned, temporary contention for cache resources can occur. Contention resolver 220 is responsible for handling such cases by deciding how cache space is allocated in response to conflicting controller requests. The contention resolver makes its decision based on the level of contention, the requests from the per-class controllers, and according to high level policies, to be further explained below.

Fairness controller 230 computes the fair share of each class based on the current performance estimate and the reference target hit rate of each class. It then adjusts the target hit rate of each class that the per-class controller must track. In an illustrative embodiment, a fairness policy may be: distribute excess resources in such a way that the resulting hit rate is proportional to the reference (target) hit rate of the class.

Operations of the QoS methodology provided by system 200 assumes that time is divided into discrete units, called rounds. At the beginning of each round, the hit rate of each application class during the previous round is recorded. Based on the hit rate measurement hᵢ of class cᵢ, the fairness controller computes a new target hit rate tᵢ^{*} (>tᵢ).

The new target hit rate tᵢ^{*} is communicated to the per-class controller of the class cᵢ. The per-class controller then computes the space allocation sᵢ required for the class to achieve tᵢ^{*}, and makes a request to the contention resolver. Upon receiving the space requests from all the per-class controllers for the new round, the contention resolver determines the actual space allocation sᵢ^{*} to each class. Space allocations for the new round are thus decided. The hit ratios for each class are recorded at the end of the round, and the above procedure repeated.

It is to be noted that the length of the round involves making a tradeoff between the stability of the system and its adaptability. If the duration of the round is increased, the delay in cache control may be better accounted for. However, this will slow down the speed at which the system can adapt to changes. In an illustrative embodiment, the round is set to be long enough so that the number of accesses occurring during the round represents a small multiple of the number of blocks allocated to the class. It has been determined that this duration is the smallest time interval for ensuring that the measured hit rate has reasonable accuracy. For example, if the size of the total cache is 20,000 disk blocks, the duration of the round is set to a small multiple of 20,000 disk accesses, e.g., cache adaptation every 40,000 disk accesses.

The modular architecture of the invention has several advantages compared to a monolithic controller alternative. First, the complexity of controller design is significantly reduced since each component performs relatively simple and well-defined operations. Second, the modular design allows for the “plug in” of new modules as they become available. For example, a per-class controller may be upgraded without having to change the fairness controller and the contention resolver. Similarly, different fairness or contention resolution policies may be implemented, according to high-level administrative goal.

Illustrative detailed designs of each component in the proxy cache storage architecture 200 of FIG. 2 will now be described. In accordance with these descriptions, the following notations (symbols and corresponding meanings) will be used:

| | |
|---|---|
| hᵢ, hᵢ′ | hit rate, measure hit rate of class cᵢ |
| tᵢ | reference hit rate (or hit rate goal) of class cᵢ |
| tᵢ* | target hit rate set by the fairness controller |
| sᵢ | space allocation demand by the per-class controller |
| sᵢ* | actual space allocation by the contention resolver |
| S | total cache space |
| α | weight of the linear controller |
| ψ | weight of the gradient controller |
| K_{P}, K_{I}, K_{D} | feedback gain of the PID controller |
| β | decay parameter of the retrospective controller |

A. Per-Class Controller

In essence, the per-class controller is a feedback controller that takes the current cache space allocation sᵢ and the measured hit rate hᵢ as input parameters, and produces the new cache space allocation sᵢ for the class to meet tᵢ^{*} as an output. The per-class controller tracks the target hit rate even when the user workload changes dynamically. In addition, it is desirable that the hit rate variation and the changes in the space allocated to the class be small.

While many classes of control methodologies may be used and/or adapted for use in accordance with the invention, the detailed description to follow describes four classes of control methodologies that may be employed, e.g., linear control, gradient-based control, PID (proportional, integral, and derivative) control, and retrospective control. A hybrid control methodology is also described. As will be explained, retrospective control and hybrid control may be used in preferred embodiments.

(i) Linear Controller

The linear controller is the simplest among the four controllers. It adjusts the cache space allocation according to the following rule:

sᵢ(n+1)=sᵢ(n)+a(tᵢ−hᵢ(n)). (2)

Recall that tᵢ denotes the target reference hit rate and hᵢ(n) denotes the measured hit rate in the n^{th} round. In short, the linear controller simply adjusts cache space according to the difference in the target and the measured value. Thus, the performance of the controller is highly sensitive to the choice of the constant weight a.

(ii) Gradient-Based Controller

This controller improves on the linear controller by adapting the constant weight, a, according to its estimate of the gradient of the space-hit rate curve. By estimating the slope, the controller adapts more effectively to the dynamics of the workload. To estimate the gradient of the curve, the rate of the measured change in hit rate to the corresponding change in space allocation in the previous interval is computed:

$${s}_{i} ( n + 1 ) = {s}_{i} ( n ) + \frac{ψ}{\frac{Δ {h}_{i}}{Δ {s}_{i}}} \times ( {t}_{i} - {h}_{i} ( n ) ) \qquad ( 3 )$$

where Δhᵢ=hᵢ(n)−hᵢ(n−1) and Δsᵢ=sᵢ(n)−sᵢ(n−1). In effect, the controller estimates the gradient of the space-hit rate curve by keeping track of the history of the changes in space allocation and the corresponding changes in hit rate. Such a gradient-based controller may be used when the overall workload characteristics is static.

(iii) PID Controller

The PID controller includes three feedback terms: proportional, integral, and derivative terms. In accordance with the invention, the operation of the PID controller can be described as follows:

$${s}_{i} ( n + 1 ) = {s}_{i} ( 0 ) + {K}_{P} {e}_{i} ( n ) + {K}_{I} {\sum }_{j}^{n - 1} {e}_{i} ( j ) + {K}_{D} Δ {e}_{i} ( n ) \qquad ( 4 )$$

where eᵢ=tᵢ−hᵢ(n), the difference between the reference and the measured value, and Δeᵢ(n)=eᵢ(n)−eᵢ(n−1). The three terms added to sᵢ(0) in the above equation denote proportional, integral, and derivative components, respectively. By controlling the gain of each term, the characteristics of the controller can be changes. For example, setting a large proportional feedback gain (K_{P}) typically leads to faster response at the cost of increased instability. On the other hand, increasing the derivative gain (K_{D}) has a dampening effect and tends to improve stability.

(iv) Retrospective Controller

The control approaches mentioned so far make limited use of the history that can be accumulated on-line in a shared storage cache. In particular, the system can explicitly maintain histories of past application request streams and derive relatively accurate predictions (e.g., through an on-line predictive model) about what the hit rate would be under various cache space allocations. This idea has motivated the design of a new controller referred to as a retrospective controller. The controller is retrospective since it refers to the history of past accesses.

In order to make accurate predictions, the retrospective controller maintains the summary MRA (most recently accessed) block list for the disk blocks which have been accessed in the recent past. This includes blocks that do not exist in the cache, for example, blocks which have been evicted and replaced by other blocks recently.

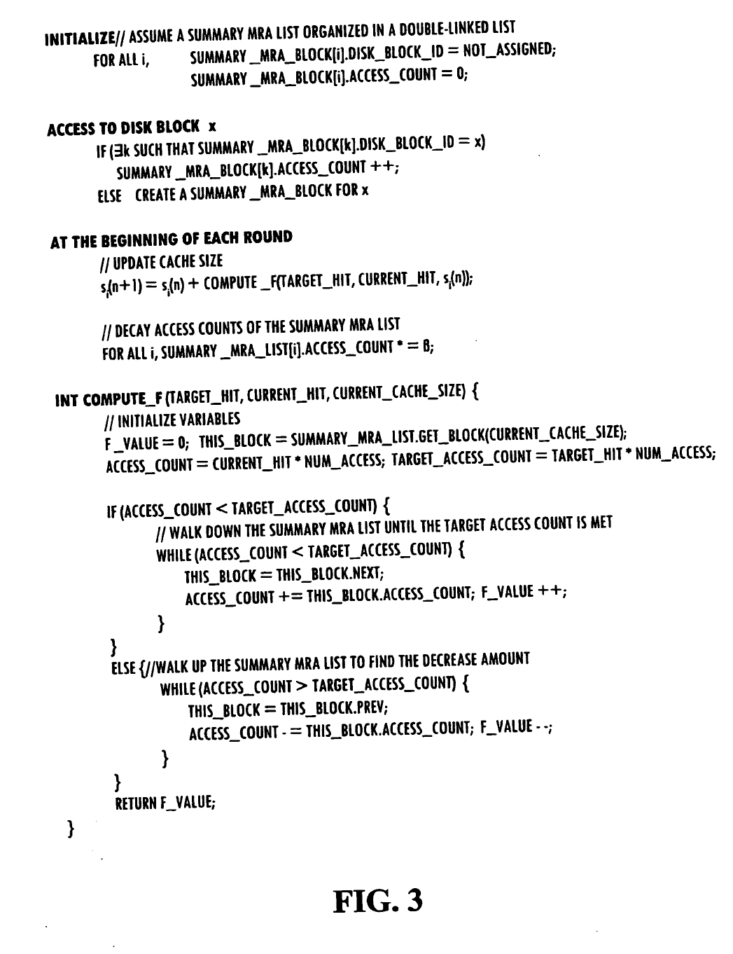

Referring now to FIG. 3, an exemplary pseudo code representation is shown of a retrospective control methodology for a single class, according to an embodiment of the present invention.

Each entry in the summary list maintains the “disk block id,” and the “access count” within the last measurement interval associated with that disk block. When the measured hit rate of the class falls short of the reference hit rate, the retrospective controller computes the number of blocks which should be added to the space allocation of the class, so that the target hit rate is achieved. This is deduced by consulting the summary MRA list. On the other hand, if the measured hit rate is higher than the reference hit rate, the retrospective controller examines the cache entry and determines the number of cache blocks which can be safely removed. In other words, the cache space allocation is updated as follows:

sᵢ(n+1)=sᵢ(n)+Fᵢ(tᵢ) (5)

where the function Fᵢ(tᵢ) returns the number of disk blocks to add or subtract (when Fᵢ is negative) from the current space allocation by looking at the summary MRA list.

To calculate Fᵢ(tᵢ), the retrospective controller traverses the list adding up the number of accesses to each block to determine how much hit rate could have been achieved by storing a certain number of blocks in the cache. Note that the summary list is maintained in MRA order to simulate the behavior of a cache implementing the LRU (least-recently used) block replacement methodology.

The retrospective controller has a more global view of the space-hit rate curve whereas the linear or gradient controller captures the slope of that curve only at the neighborhood of the current space allocation point. In general, the retrospective controller can simulate any cache replacement methodology that the cache may implement.

The access count values in the summary list entry should decay with time since they should be eventually forgotten in favor of more recent histories. This is done by maintaining an exponentially decaying average of the history using a decay parameter 0.5<β<1.

The four controllers described above have different performance characteristics and implementation complexity. The linear controller is the simplest one that can compute sᵢ(n+1) from the measured hit rate hᵢ(n) only. The gradient-based controller and the PID controllers maintain simple information readily available from the cache, i.e., the slope estimate and the PID terms of the control error, respectively. The operation for retrospective controller is more involved since it explicitly maintains the summary information of the replaced disk blocks. The computation of Fᵢ(tᵢ) can be implemented using binary search which takes O(log₂ n) for n entries in the summary list.

(v) Hybrid Controller

While conceptually simple, the implementation overhead of the retrospective controller can become significant since it needs to maintain a large number of summary MRA entries for the disk blocks that no longer reside in the cache. This overhead increases for more dynamic workloads, and also with the number of application classes managed by the cache.

To reduce this overhead of maintaining information about non-cached blocks, the invention provides for use of an approximation that maintains a simple history of past cache performance by recording the size and hit ratio relationship. In particular, the n most recent measurements, (cache_size(i), hit_ratio(i)) pairs, are recorded. Then, a weighted average (avg_size, avg_hit) is calculated using these n coordinates, weighed more heavily towards the recent past. For all cached blocks, the (block_id, access_count) information is recorded as in the above-described retrospective methodology.

So, when the controller wants to reduce the cache size, it uses the retrospective control methodology without the above-described approximation. When the controller increases the cache size, however, it estimates the desired cache space by interpolating (or extrapolating) from the current (cache_size, hit_ratio) and the weighted average (avg_size, avg_hit). In other words, the new control methodology employs the original retrospective methodology for cache size reduction and a variant of the gradient methodology for cache size increase. Thus, this methodology is referred to as a hybrid controller.

B. Fairness Controller

Before discussing the operation of the fairness controller, a notion of fairness is defined. In this illustrative description, an intuitive definition of fairness is considered which dictates that excess resources are distributed such that the effective hit rate hᵢ(>tᵢ) is proportional to the reference hit rate tᵢ. To achieve this goal, the fairness controller performs a simple calculation to modify the target hit rate of each class:

$${t}_{i}^{*} ( n + 1 ) = {t}_{i} \frac{s}{{\sum }_{j} ( \frac{{s}_{j}^{*} ( n )}{{h}_{j} ( n )} {t}_{j} )} \qquad ( 6 )$$

where S is the total cache space and sᵢ^{*}(n) is the cache space allocated to class cᵢ (i.e., Εsᵢ^{*}(n)=S). The fairness controller tries to estimate the fair hit rate targets (higher than their reference hit rates) that will consume the entire cache space. Note, however, that the fairness controller computes the distribution of the excess resources in the hit rate domain while the actual distribution is done in the space domain.

The above-described allocation minimizes the deviation of the actual hit ratio from the target hit rate set by the fairness controller, assuming that the space-hit curve can be approximated by a time-varying linear function.

It is now shown that the fairness targets computed by equation (6) minimizes the deviation of the total space demand of the per-class controllers from the actual cache space.

Suppose the hit rate versus cache size relationship is modeled as a time-varying linear function for each class, i.e., for class cᵢ in the n-th round, sᵢ(n)=gᵢ(n)×hᵢ(n), where hᵢ(n) is the hit rate, sᵢ(n) the cache space allocated, and gᵢ(n) a time-varying coefficient. Note that using a time-varying linear function, the true relation between hit and space can be approximated for the small region around the current values.

In order for the new target hit to be proportional to reference target hit, i.e., at any instance, n, tᵢ^{*}(n)=K(n)tᵢ for all i, where K(n) is constant over i but may vary over time. K(n) is referred to as the fairness margin.

The optimization goal is, at a given round n, to determine the fairness margin K(n+1) (and thus determine tᵢ^{*}(n+1)) so as to minimize the difference between the available cache size and the sum of requested cache sizes to meet the fairness target. In other words, the following is minimized:

$$\vert {\sum }_{i}^{} {s}_{i} ( n ) - S \vert \qquad ( 7 )$$

where S is the total cache space.

Let sᵢ^{*}(n) be the cache space actually allocated to class cᵢ (i.e., Εᵢsᵢ^{*},(n)=S) by the contention resolver. Assuming that the per-class controller can estimate exactly the right amount of cache space needed to meet a given target, and that the above time-varying linearization model holds, it follows that:

sᵢ(n)≈gᵢ(n)tᵢ^{*}(n), and sᵢ^{*}(n)=gᵢ(n)hᵢ(n). (8)

Obviously, the optimization goal of equation (7) is minimized if Εᵢsᵢ(n)=S, and thus:

$${\sum }_{i}^{} {s}_{i} ( n ) = {\sum }_{i}^{} {g}_{i} ( n ) {t}_{i}^{*} ( n ) = S . \qquad ( 9 )$$

Since tᵢ^{*}(n)=K(n)tᵢ:

$${\sum }_{i}^{} {g}_{i} ( n ) K ( n ) {t}_{i} = K ( n ) {\sum }_{i}^{} {g}_{i} ( n ) {t}_{i} = S . \qquad ( 10 )$$

Therefore, to minimize equation (7), at each round n, a new fairness target hit would be set as:

$${t}_{i}^{*} ( n + 1 ) = K ( n ) {t}_{i} = {t}_{i} \frac{s}{{\sum }_{j}^{} {g}_{j} ( n ) {t}_{j}} . \qquad ( 11 )$$

However, since gᵢ(n)=sᵢ^{*}(n)/hᵢ(n) which can be measured from the effective hit rate and allocated cache size, it is concluded that:

$${t}_{i}^{*} ( n + 1 ) = {t}_{i} \frac{s}{{\sum }_{j}^{} ( \frac{{s}_{j}^{*} ( n )}{{h}_{j} ( n )} {t}_{j} )} . \qquad ( 12 )$$

Note that the success of this fairness policy depends on the accuracy of the time-varying linearization model and the ability to estimate the required allocation to achieve the target performance level. In the QoS methodology of the invention, the latter factor may be decided by the proper design of the per-class controller.

C. Contention Resolver

In the absence of contention (cache space>total demand), the contention resolver may make only minor adjustments to allocation requests from the per-class controllers. This step is implemented because the target hit rates specified by the fairness controller are typically not perfect and the per-class controllers independently compute their cache space allocation requests without any coordination between them. The adjustment is a simple scaling operation.

On the other hand, when contention occurs (cache space<total demand), the contention resolver handles this temporary overload. In general, there may be two policies.

The first policy is to treat all classes equally and allocates

$${s}_{i} * \frac{s}{{\sum }_{i}^{} {s}_{i}}$$

to every class. With this proportional allocation, all classes observe temporary service violation, although the long term service goals are still ensured.

The second policy considers a scenario when some classes are more important than the others. Under this policy, referred to herein as “prioritized allocation,” the contention resolver tries to ensure that high priority classes do not experience short term service violations

One approach that can be used to implement prioritization is to allocate the cache space to the highest priority class first, then to the next highest priority class and so on, until all cache blocks are fully allocated. However, this reactive approach is affected by the inherent delay in caching. Thus, allocating more space does not immediately translate into an improvement in hit rate because it takes some time to utilize additional cache space and reap benefits from it.

Therefore, the invention may preferably implement a proactive approach, which provisions more resources to higher priority classes even when there is no contention. This goal is achieved by specifying differentiated adaptation rates to different priority classes when reducing cache space allocations. In particular, a smaller reduction rate is specified for the higher priority classes than for the lower priority classes.

More specifically, when one of the per-class controllers request a cache size reduction, the contention resolver identifies the priority of the class and adjusts the cache reduction amount by applying the reduction rate γᵢ(≦1) of the class. In this way, the high priority classes release their allocated cache space more slowly than the lower priority classes and, therefore, they are less likely to suffer from sudden space constraints due to workload changes.

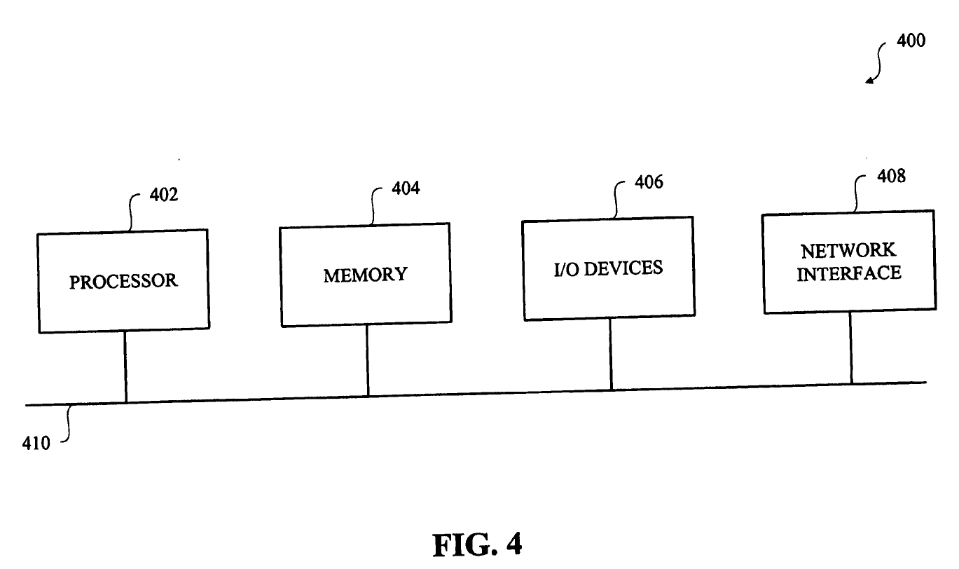

Referring lastly to FIG. 4, a block diagram illustrates an exemplary computing system environment for implementing a proxy cache storage system according to an embodiment of the present invention. More particularly, the functional blocks illustrated in FIG. 2 (e.g., per-class controllers, contention resolver, fairness controller, caches) may implement such a computing system 400 to perform the techniques of the invention. For example, one or more servers implementing the proxy cache storage principles of the invention may implement such a computing system. A client device (e.g., storage client device 110 of FIG. 1) and a remote storage system (system 130 of FIG. 1) may also implement such a computing system. Of course, it is to be understood that the invention is not limited to any particular computing system implementation.

In this illustrative implementation, a processor 402 for implementing at least a portion of the methodologies of the invention is operatively coupled to a memory 404, input/output (I/O) device(s) 406 and a network interface 408 via a bus 410, or an alternative connection arrangement.

It is to be appreciated that the term “processor” as used herein is intended to include any processing device, such as, for example, one that includes a central processing unit (CPU) and/or other processing circuitry (e.g., digital signal processor (DSP), microprocessor, etc.). Additionally, it is to be understood that the term “processor” may refer to more than one processing device, and that various elements associated with a processing device may be shared by other processing devices.

The term “memory” as used herein is intended to include memory and other computer-readable media associated with a processor or CPU, such as, for example, random access memory (RAM), read only memory (ROM), fixed storage media (e.g., hard drive), removable storage media (e.g., diskette), flash memory, etc. For example, memory 404 may be used to implement the cache proxies 240-1 through 240-N of FIG. 2.

In addition, the phrase “I/O devices” as used herein is intended to include one or more input devices (e.g., keyboard, mouse, etc.) for inputting data to the processing unit, as well as one or more output devices (e.g., CRT display, etc.) for providing results associated with the processing unit.

Still further, the phrase “network interface” as used herein is intended to include, for example, one or more devices capable of allowing the computing system 400 to communicate with other computing systems. Thus, the network interface may include a transceiver configured to communicate with a transceiver of another computing system via a suitable communications protocol, over a suitable network, e.g., the Internet, private network, etc. It is to be understood that the invention is not limited to any particular communications protocol or network.

It is to be appreciated that while the present invention has been described herein in the context of a proxy cache storage system, the methodologies of the present invention may be capable of being distributed in the form of computer readable media, and that the present invention may be implemented, and its advantages realized, regardless of the particular type of signal-bearing media actually used for distribution. The term “computer readable media” as used herein is intended to include recordable-type media, such as, for example, a floppy disk, a hard disk drive, RAM, compact disk (CD) ROM, etc., and transmission-type media, such as digital and analog communication links, wired or wireless communication links using transmission forms, such as, for example, radio frequency and optical transmissions, etc. The computer readable media may take the form of coded formats that are decoded for use in a particular data processing system.

Accordingly, one or more computer programs, or software components thereof, including instructions or code for performing the methodologies of the invention, as described herein, may be stored in one or more of the associated storage media (e.g., ROM, fixed or removable storage) and, when ready to be utilized, loaded in whole or in part (e.g., into RAM) and executed by the processor 402.

In any case, it is to be appreciated that the techniques of the invention, described herein and shown in the appended figures, may be implemented in various forms of hardware, software, or combinations thereof, e.g., one or more operatively programmed general purpose digital computers with associated memory, application-specific integrated circuit(s), functional circuitry, etc. Given the techniques of the invention provided herein, one of ordinary skill in the art will be able to contemplate other implementations of the techniques of the invention.

Advantageously, as described in detail herein, the present invention effectuates service differentiation in storage caches. It is to be appreciated that the caches may be deployed in servers, inside the network (e.g., storage-area network proxies, gateways), or at storage side devices to provide differentiated services for application I/O requests going through the caches. Furthermore, the present invention assures applications a contracted (e.g., via SLA) quality of service (e.g., expressed as response time or hit rate). The invention can achieve this goal by dynamically allocating cache space among competing applications in response to their access patterns, priority levels, and target hit rate/response time goals.

Furthermore, as described in detail herein, the invention provides a scaleable system for dynamic cache space allocation among a large number of competing applications issuing block I/O requests through a shared block cache in a shared storage environment. The actual storage devices (disks or tapes) may be remotely located and connected via networks.

The invention, as described in detail herein, also ensures a minimum contracted response time for application requests to data blocks in a remote storage device by adaptively allocating space in the storage cache and/or by dynamically scheduling application data and control requests on the link from the cache to the back-end storage location. The storage cache ensures a minimum contracted hit ratio to each application class via adaptive cache space allocation and access control. The cache control architecture may include multiple per-class controllers acting independently to increase or decrease the space allocation of each class to meet the required target hit rate. The cache control architecture may also include a contention resolver and a fairness controller to resolve conflicts from the demands of the per-class controllers.

Still further, as described in detail herein, the invention provides techniques for adjusting the space allocation in the cache system for an application based on recording the history of previous accesses, and using an on-line predictive model to calculate the appropriate future allocation that would achieve the target hit rate as predicted by this access history.

The invention also provides for recording history of previous accesses by maintaining a time-averaged correspondence between cache size allocation and the observed hit ratio, such that the space required is minimal.

The invention also provides for calculating the future allocation in accordance with a periodic process, wherein the period may be adaptively changed so that an accurate hit ratio measurement is possible even when the access frequencies of applications accessing the cache are very different.

The invention also provides for increasing or decreasing cache resources while ensuring that, under overload, the event of high-priority classes missing their target hit ratio is minimized by decreasing the cache space allocated to a higher priority class by a lesser degree than that allocated to a lower-priority class when overload occurs. The available cache space may be allocated to satisfy the minimum cache space requirement of a high priority class first before allocating to any lower priority classes.

Still further, the fairness controller of the invention may distribute excess cache space according to a fairness policy specified by an administrator. Also, the fairness controller can distribute excess cache space to application classes in such a manner that the effective hit ratios are proportional to their contracted hit ratios.

Although illustrative embodiments of the present invention have been described herein with reference to the accompanying drawings, it is to be understood that the invention is not limited to those precise embodiments, and that various other changes and modifications may be made by one skilled in the art without departing from the scope or spirit of the invention.

What is claimed is:

1. An automated method of allocating storage space among classes of applications and/or users in a shared storage environment, the method comprising the steps of:
obtaining a storage access request from at least one application and/or user; and
determining a storage space allocation for the storage access request based on an access pattern associated with the at least one application and/or user and a prespecified target response time goal associated with a class of the at least one application and/or user.

2. The method of claim 1, wherein the storage space comprises cache storage space.

3. The method of claim 1, wherein the step of determining a storage space allocation for the storage access request is also based on a prespecified priority level associated with the class of the at least one application and/or user.

4. The method of claim 1, wherein the target response goal specifies that, for the given class of the at least one application and/or user, an average hit rate measured over a given time period is not less than a target hit rate.

5. The method of claim 1, wherein when a conflict exists between the storage access request and another storage access request from at least another application and/or user, further comprising the step of determining a storage space allocation for both storage access requests by resolving the conflict based on a contention resolution policy.

6. The method of claim 5, wherein the contention resolution policy comprises proportionally allocating storage space for both storage access requests.

7. The method of claim 5, wherein the contention resolution policy specifies allocating storage space for each storage access request based on a priority associated with the class of the application and/or user.

8. The method of claim 7, wherein the contention resolution policy specifies allocating a minimum storage space requirement of a higher priority class before allocating storage space to any lower priority class.

9. The method of claim 7, wherein the contention resolution policy ensures that under overload, the event of high-priority classes missing their target hit ratio is minimized by decreasing the storage space allocated to a higher priority class by a lesser degree than that allocated to a lower-priority class when overload occurs.

10. The method of claim 1, further comprising the step of distributing excess storage space based on a fairness policy.

11. The method of claim 10, wherein the fairness policy specifies distributing excess storage space to classes in such that actual effective hit ratios are proportional to their contracted hit ratios.

12. The method of claim 1, wherein the access pattern is obtained from a time-averaged correspondence between storage space allocation and an observed hit ratio.

13. Apparatus for allocating storage space among classes of applications and/or users in a shared storage environment, comprising:
a memory for implementing storage; and
at least one processor coupled to the memory and operative to: (i) obtain a storage access request from at least one application and/or user; and (ii) determine a storage space allocation for the storage access request based on an access pattern associated with the at least one application and/or user and a prespecified target response time goal associated with a class of the at least one application and/or user.

14. The apparatus of claim 13, wherein the storage space comprises cache storage space.

15. The apparatus of claim 13, wherein the operation of determining a storage space allocation for the storage access request is also based on a prespecified priority level associated with the class of the at least one application and/or user.

16. The apparatus of claim 13, wherein the target response goal specifies that, for the given class of the at least one application and/or user, an average hit rate measured over a given time period is not less than a target hit rate.

17. The apparatus of claim 13, wherein when a conflict exists between the storage access request and another storage access request from at least another application and/or user, the at least one processor is further operative to determine a storage space allocation for both storage access requests by resolving the conflict based on a contention resolution policy.

18. The apparatus of claim 13, wherein the at least one processor is further operative to distribute excess storage space based on a fairness policy.

19. The apparatus of claim 13, wherein the access pattern is obtained from a time-averaged correspondence between storage space allocation and an observed hit ratio.

20. An article of manufacture for allocating storage space among classes of applications and/or users in a shared storage environment, comprising a machine readable medium containing one or more programs which when executed implement the steps of:
obtaining a storage access request from at least one application and/or user; and
determining a storage space allocation for the storage access request based on an access pattern associated with the at least one application and/or user and a prespecified target response time goal associated with a class of the at least one application and/or user.

21. The article of claim 20, wherein the storage space comprises cache storage space.

22. The article of claim 20, wherein the step of determining a storage space allocation for the storage access request is also based on a prespecified priority level associated with the class of the at least one application and/or user.

23. The article of claim 20, wherein the target response goal specifies that, for the given class of the at least one application and/or user, an average hit rate measured over a given time period is not less than a target hit rate.

24. The article of claim 20, wherein when a conflict exists between the storage access request and another storage access request from at least another application and/or user, further comprising the step of determining a storage space allocation for both storage access requests by resolving the conflict based on a contention resolution policy.

25. The article of claim 20, further comprising the step of distributing excess storage space based on a fairness policy.

26. The article of claim 20, wherein the access pattern is obtained from a time-averaged correspondence between storage space allocation and an observed hit ratio.

27. An automated method of allocating storage space among classes of applications in a shared storage environment, the method comprising the steps of:
obtaining a storage access request from an application; and
based on a service level agreement between an owner of the application and a service provider, determining a cache space allocation for the storage access request based on an access pattern associated with the application and a prespecified target response time goal associated with a class of the application.

28. Apparatus for allocating cache space among classes of applications and/or users in a shared storage environment, comprising:
a plurality of per-class controllers, each per-class controller being operative to determine a cache space allocation for its corresponding class based on a current measured hit rate and a current cache space allocation for its corresponding class; and
a contention resolver coupled to the plurality of per-class controllers and operative to resolve cache space allocation in response to conflicting requests from at least two of the per-class controllers.

29. The apparatus of claim 28, further comprising a fairness controller coupled to the plurality of per-class controllers and the contention resolver for computing a fair cache allocation share of each class based on a current performance estimate and a target hit rate of each class, wherein the fairness controller adjusts the target hit rate of each class that the per-class controller is to track.

30. The apparatus of claim 28, wherein at least one per-class controller implements a retrospective control mechanism for cache size reduction and a gradient-based control mechanism for cache size increase.
